(19) United States
(12) Patent Application Publication
(10) Pub. No.: US 2017/0148344 A1
(43) Pub. Date: May 25, 2017

(54) Anatomical Landmark Instruction Apparel And Associated Methods

(71) Applicant: Rachel Abramowitz, New York, NY (US)

(72) Inventor: Rachel Abramowitz, New York, NY (US)

(21) Appl. No.: 14/947,165

(22) Filed: Nov. 20, 2015

(51) Int. Cl. G09B 19/00; A43B 3/00; A43B 5/12; A41B 9/08; A41D 27/08

(52) U.S. Cl. CPC G09B 19/0015; A41B 9/08; A41D 27/08; A43B 5/12; A43B 3/0078

(57) ABSTRACT

Technology is provided for a garment to facilitate communication between an instructor and an instructee. The garment includes a wearable article and indicia positioned on the wearable article to correspond to a feature of the human body when worn by an instructee. An instructor can refer to the indicia to communicate to the instructee how to move the indicia to a desired position by moving the trainee's anatomical features, thereby achieving a desired anatomical configuration.

### TECHNICAL FIELD

This patent application is directed to apparel and, more specifically, to instructional apparel.

### BACKGROUND

When teaching a student or instructee a new skill involving movements of the instructee's body, it can be difficult to communicate the proper body movements and positions with words alone. In ballet, for example, commands such as “pull your ribs into your back,” “square your hips,” and “lift your pelvis” are often difficult for students to put into practice due to their abstract nature.

### BRIEF DESCRIPTION OF THE DRAWINGS

Embodiments of the anatomical landmark instruction apparel and associated methods introduced herein may be better understood by referring to the following Detailed Description in conjunction with the accompanying drawings, in which like reference numerals indicate identical or functionally similar elements.

FIG. 1 is an isometric view of an anatomical landmark instruction leotard according to a representative embodiment.

FIG. 2 is a front view in elevation of the leotard shown in FIG. 1.

FIG. 3 is a back view in elevation of the leotard shown in FIGS. 1 and 2.

FIG. 4 is a left side view of the leotard shown in FIGS. 1-3.

FIG. 5 is a right side view of the leotard shown in FIGS. 1-4.

FIG. 6 is an isometric view of an anatomical landmark instruction leotard according to another representative embodiment.

FIG. 7 is a front view in elevation of the leotard shown in FIG. 6.

FIG. 8 is a back view in elevation of the leotard shown in FIGS. 6 and 7.

FIG. 9 is a left side view of the leotard shown in FIGS. 6-8.

FIG. 10 is a right side view of the leotard shown in FIGS. 6-9.

FIG. 11 is an isometric view of an anatomical landmark instruction slipper according to a representative embodiment.

FIG. 12 is a left side view of the slipper shown in FIG. 11.

FIG. 13 is a top plan view of the slipper shown in FIGS. 11 and 12.

FIG. 14 is a bottom plan view of the slipper shown in FIGS. 11-13.

FIG. 15 is an isometric view of an anatomical landmark instruction slipper according to another representative embodiment.

FIG. 16 is a left side view of the slipper shown in FIG. 15.

The headings provided herein are for convenience only and do not necessarily affect the scope or meaning of the claimed embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to limit the embodiments described. On the contrary, the embodiments are intended to cover all modifications, equivalents, and alternatives falling within the scope of the embodiments as defined by the appended claims.

### DETAILED DESCRIPTION

### Overview

Anatomical landmark instruction apparel is provided that includes indicia such as stripes, color blocks, and/or shapes that encourage a better understanding of an instructor's explanations and corrections of the physical movements of an activity, such as ballet, for example. The indicia provide visual markers or landmarks corresponding to anatomical features that a user or instructee can manipulate to achieve the desired pose or anatomical configuration. Garments to facilitate communication between an instructor and an instructee are provided herein. In an embodiment, the garment includes a wearable article and indicia positioned on the wearable article to correspond to a feature of the human body when worn by an instructee. An instructor can refer to the indicia to communicate to the instructee how to move the indicia to a desired position by moving the trainee's anatomical features, thereby achieving a desired anatomical configuration.

Methods of instructing an instructee to achieve a desired anatomical configuration are also disclosed. In an embodiment, the method includes providing the instructee with a garment. The garment includes an article wearable by the instructee; and indicia positioned on the article adjacent one or more of the instructee's anatomical features when worn by the instructee. The instructee is instructed to move the indicia to a desired position by moving the instructee's anatomical features, thereby achieving a desired anatomical configuration.

### General Description

Various examples of the articles and methods introduced above will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

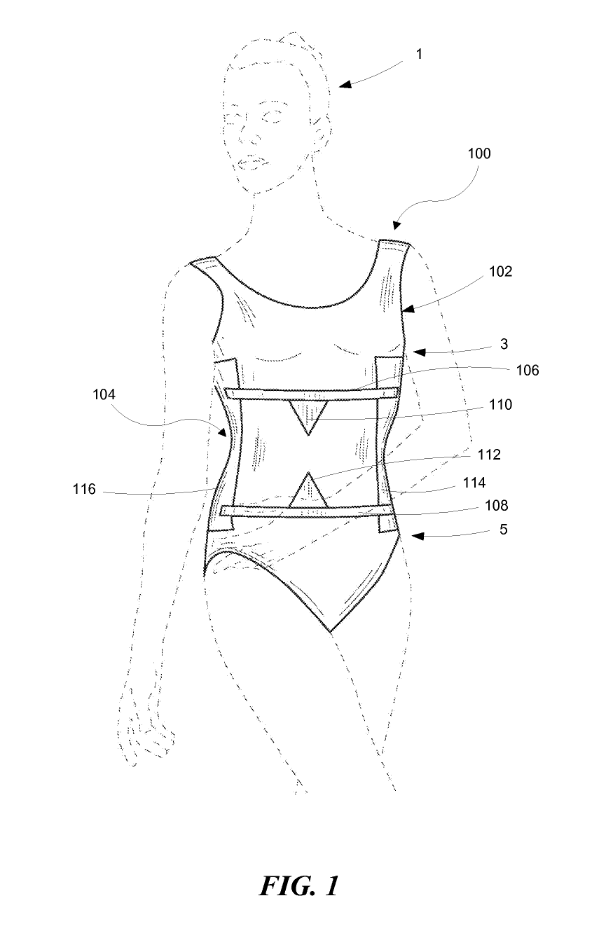

FIG. 1 illustrates a garment 100 including anatomical landmarks or indicia 104 to facilitate communication between an instructor (not shown) and a user or instructee 1. In an embodiment, the garment 100 includes a wearable article in the form of a leotard 102. In the illustrated embodiment, the leotard 102 is configured for ballet instruction.

The indicia 104 are positioned on the wearable article 102 to correspond to anatomical features of the human body when worn by the instructee 1. The instructor can refer to the indicia 104 to communicate to the instructee 1 how to move the indicia 104 to a desired position by moving the trainee's anatomical features, thereby achieving a desired anatomical configuration. For example, the indicia 104 can include first and second horizontal stripes 106 and 108, respectively. The first stripe 106 is positioned on the leotard 102 such that it extends under the instructee's bust 3 when the leotard 102 is worn by the instructee. The second stripe 108 is positioned on the leotard 102 such that it extends horizontally across the instructee's hips 5. Thus, the instructor can refer to the first and second horizontal stripes 106 and 108 to communicate to the instructee 1 how to move to a desired position by moving the trainee's anatomical features (e.g., bust 3 and hips 5) associated with the stripes. For example, the instructor can refer to the first stripe 106 by instructing the instructee 1 to “use your muscles to lower the stripe across your bust while keeping that stripe level.” Similarly, the instructor can refer to the second stripe 108 by instructing the instructee 1 to “use your muscles to raise the stripe across your hips while keeping that stripe level.” Thus, the instructor can refer to the indicia 104 to instruct the instructee 1 to move his or her anatomical features to achieve the “tendu” pose in ballet.

In some embodiments, the leotard 102 can include directional indicators or arrows to communicate to the user of the leotard 102 how or which direction to move his or her anatomical features to achieve the desired pose or anatomical configuration. For example, leotard 102 includes upper and lower triangles 110 and 112, respectively. The upper triangle 110 is positioned adjacent the first stripe 106 and the lower triangle 112 is positioned adjacent second stripe 108. The upper triangle 110 is positioned to point downward and the lower triangle 112 is positioned to point upward. Thus, the upper and lower triangles 110 and 112 communicate to the user to move the upper and lower stripes 106 and 108 toward each other. In some embodiments, the garment 100 includes indicia that are to be moved, by moving anatomical features, until the indicia come together or touch. For example, when the tips of the upper and lower triangles 110 and 112 move toward each other or touch, it indicates to the user that they have achieved the desired pose or position. In at least one embodiment, the garment can include dots that are to be moved toward each other, touched together, or connected together. It should be appreciated that the material of the garment 100 can be folded, stretched, wrinkled, or otherwise manipulated by the user to move the indicia as instructed or as communicated to the user by the directional indicators or arrows.

In some embodiments, the garment 100 includes left and right side bars 114 and 116, respectively. The side bars 114/116 can be used, for example, to communicate to the user to keep his or her body entirely square to a mirror, not twisted to one side or the other. For example, the instructor can refer to the side bars 114/116 by instructing the instructee 1 that “the side bars should be even when squared off. In a “croisé” position, you should still see both panels, though one will be more pronounced than the other.” Thus, the side bars 114/116 communicate to the user (e.g., a reminder) and can be referred to by an instructor to help prevent the user/instructee from turning too far to the side in this position.

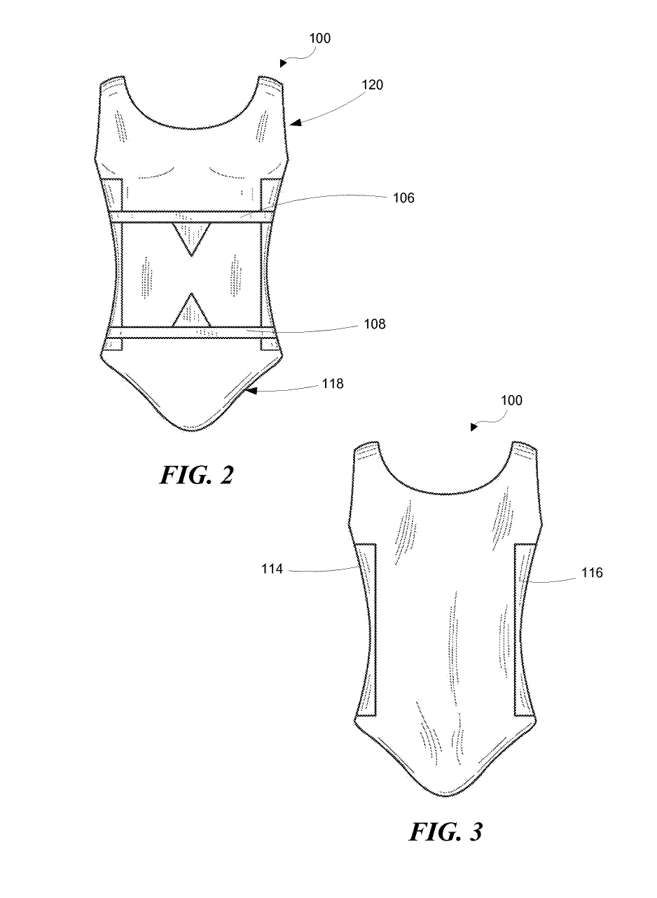

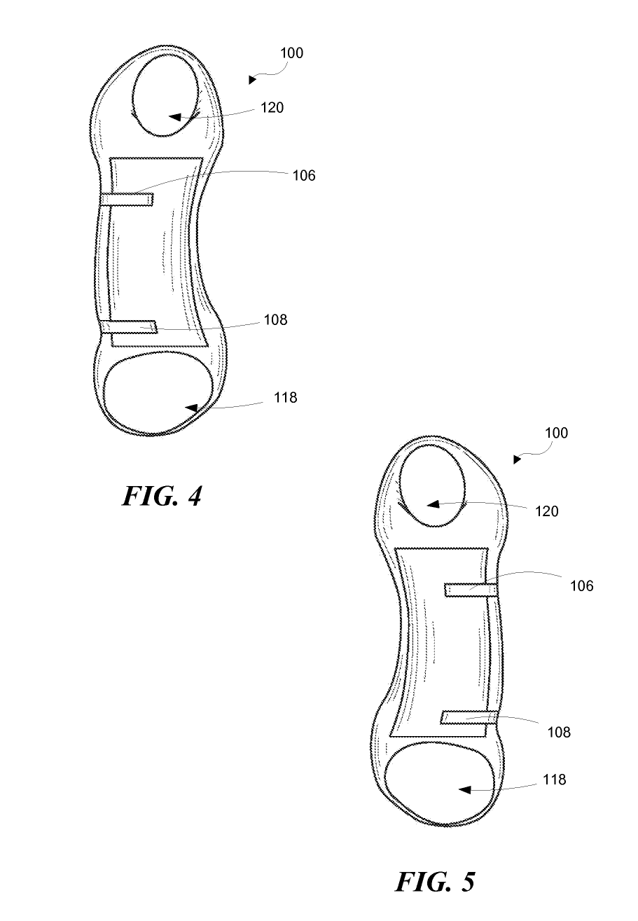

With further reference to FIGS. 2-5, it can be appreciated that the upper stripe 106 is positioned on the leotard 102 below the arm openings 120. Similarly, the lower stripe 108 is positioned just above the leg openings 118. In some embodiments, the indicia 104 (e.g., stripes 106 and 108) comprise panels of separate material sewn into the wearable article. In other embodiments, the indicia is printed (e.g., silkscreen) onto the wearable article. In some embodiments, the indicia include a color or pattern. Thus, an instructor can refer to the indicia by shape and/or color.

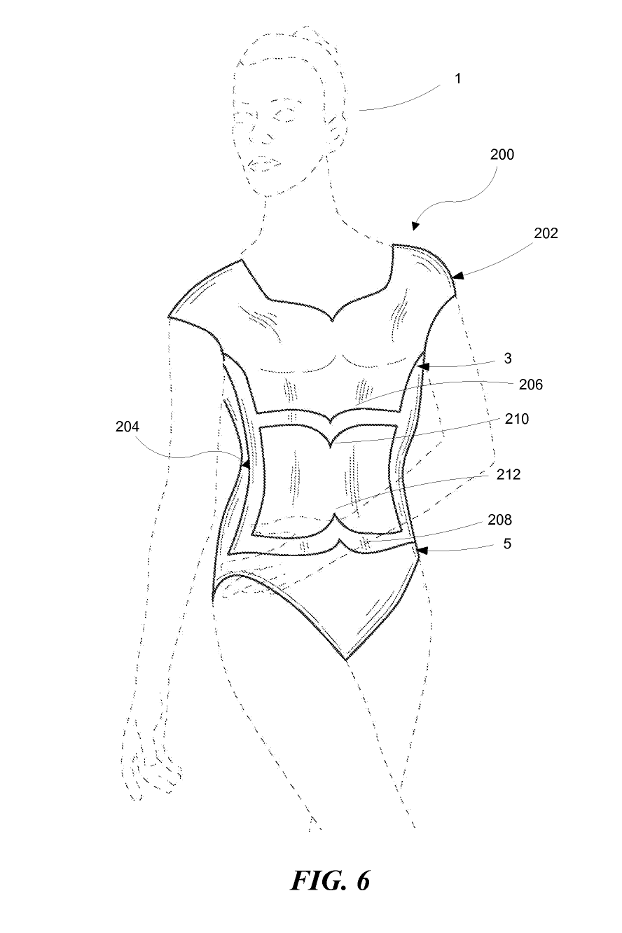

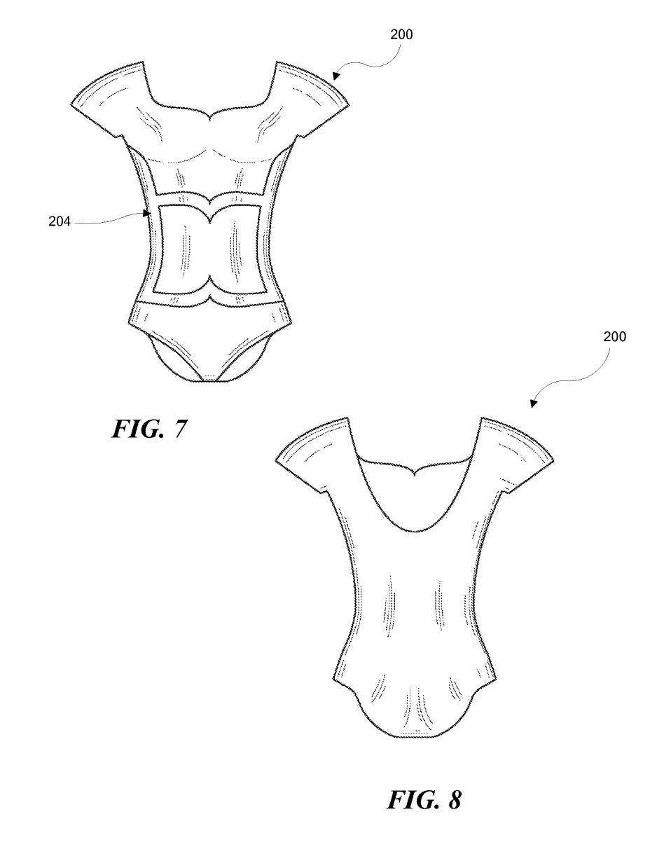

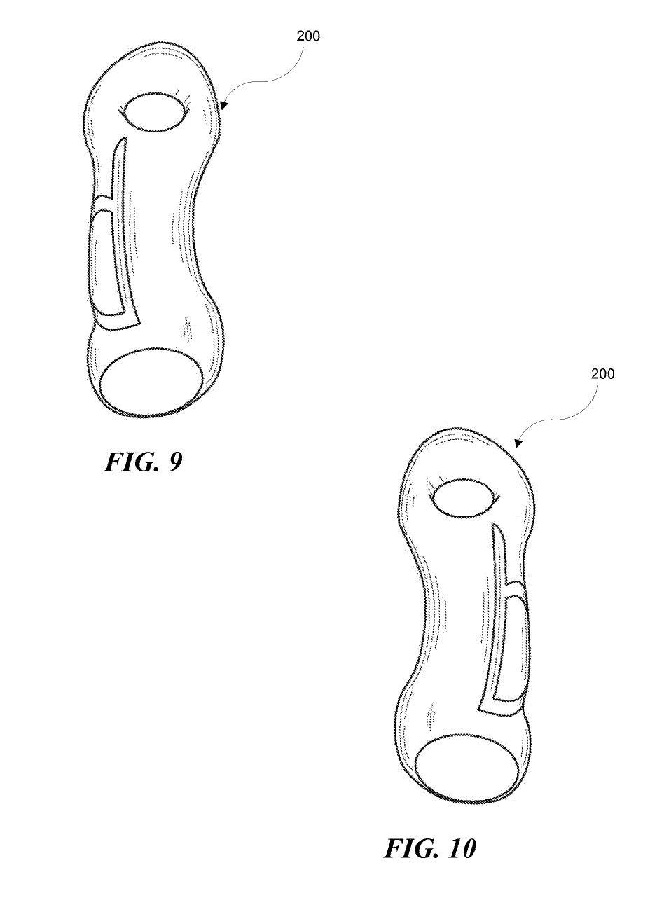

FIGS. 6-10 illustrate a garment 200 including anatomical landmarks or indicia 204 to facilitate communication between an instructor and a user or instructee 1. Garment 200 incorporates similar technology as that described above with respect to FIGS. 1-9. However, in this embodiment, the indicia 204 include first and second curly brackets 206 and 208, respectively. The brackets 206 and 208 include a central pointed portion 210 and 212. The upper pointed portion 210 is positioned to point downward and the lower pointed portion 212 is positioned to point upward. Thus, the upper and lower pointed portions 210 and 212 communicate to the user to move the upper and lower brackets 206 and 208 toward each other.

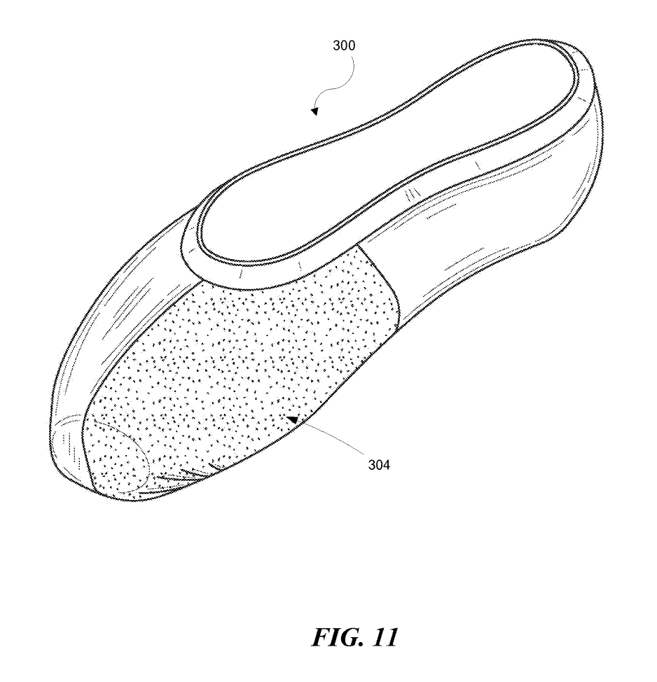

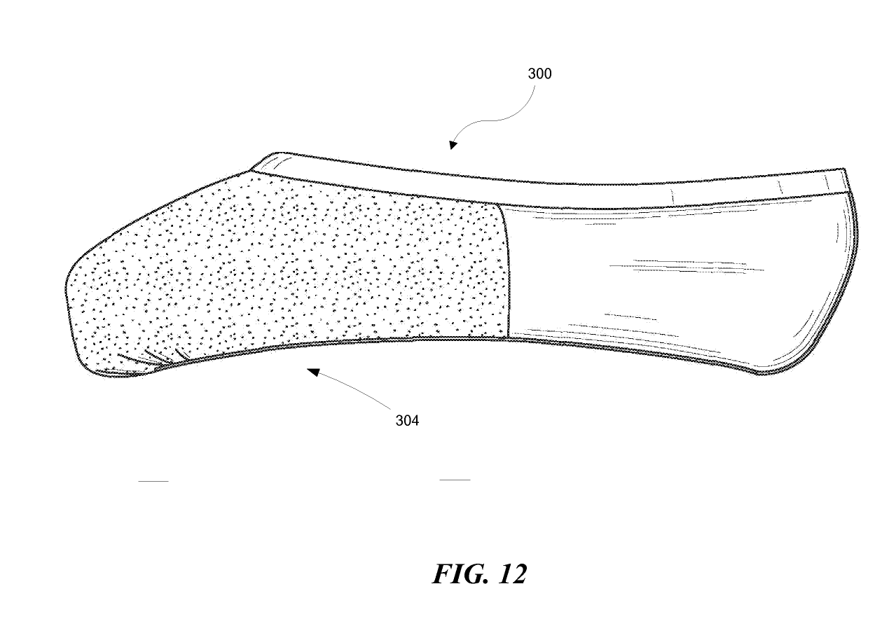

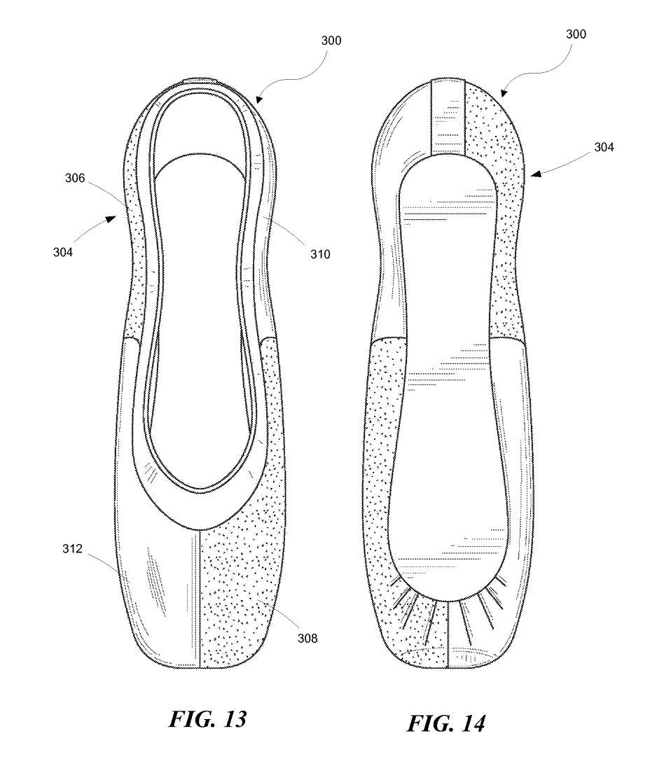

FIGS. 11-14 illustrate a ballet shoe or slipper 300 including anatomical landmarks or indicia 304 to facilitate communication between an instructor and a user or instructee. With specific reference to FIG. 13, the indicia 304 include color-blocked quadrants 306, 308, 310, and 312. For example, the first quadrant 306 can be green; the second quadrant 308 can be red; the third quadrant 310 can be blue, and the fourth quadrant 312 can be purple. Alternatively, or in addition to color, each quadrant can have a different pattern. An instructor can refer to the quadrants 306, 308, 310, and 312 to communicate to the instructee how to move to a desired position by moving the trainee's anatomical features (e.g., heel and toes) associated with the quadrants. For example, the instructor can refer to the first stripe 106 by instructing the instructee to “make sure as you tendu that you can see the purple part of the shoe from behind the heel and that you don't see the green part of the shoe running across the tips of the toes.” The shoe quadrants are meant to facilitate the proper foot and ankle position in “tendus” and “dégagés”. The leg, ankle, and foot should be turned out so that the instructee can nearly see the back heel quadrant and not the front heel quadrant.

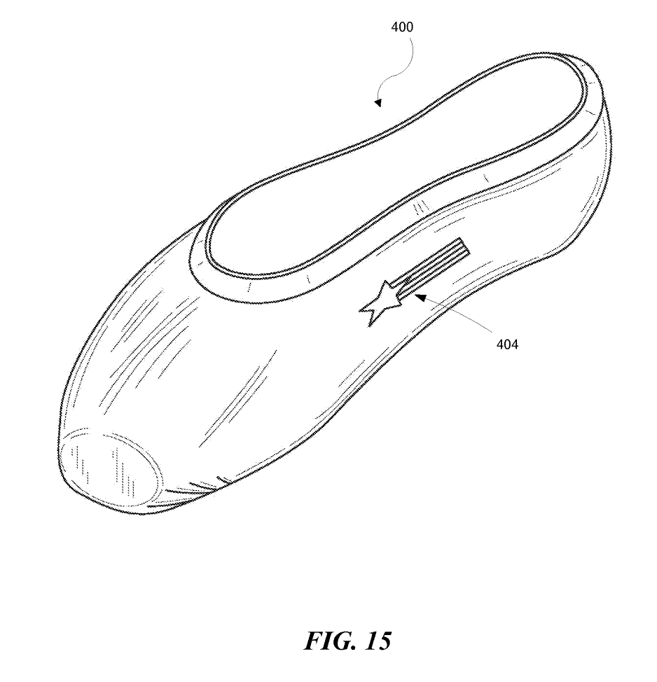

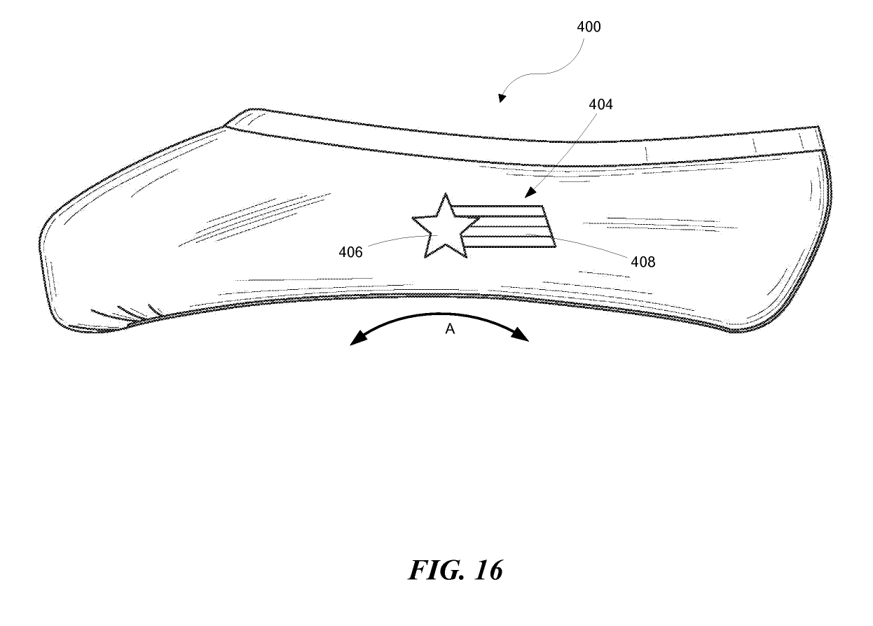

FIGS. 15 and 16 illustrate a ballet shoe or slipper 400 including anatomical landmarks or indicia 404 to facilitate communication between an instructor and a user or instructee. In the depicted embodiment of FIGS. 15 and 16, the indicia 404 include a representation (e.g., symbol) of a shooting star 406 with tails 408. The indicia 404 are positioned on the inside of the foot proximate the user's arch. The indicia 404 are positioned such that the user can follow the symbol as the leg turns out. In addition, the tails 408 also bend along an arc A (from a straight line into a “rainbow”) when the foot sickles. Thus, the indicia 404 communicate to a user that they have properly sickled (e.g., arched) his or her foot. It should be appreciated that the material of the slipper 400 bends and/or stretches as a result of the user arching his or her foot, thereby causing the tails 408 to transform into a rainbow shape that in turn communicates to the user that they have properly sickled his or her foot.

The garments described herein can facilitate methods of instructing an instructee to achieve a desired anatomical configuration. In an embodiment, such a method includes providing the instructee with the garment including an article wearable by the instructee and indicia positioned on the article adjacent one or more of the instructee's anatomical features (e.g., bust and hips) when worn by the instructee. The method further includes instructing the instructee to move the indicia to a desired position by moving the instructee's anatomical features, thereby achieving a desired anatomical configuration. In some embodiments, the method includes verbally instructing the instructee with reference to the indicia. In other embodiments, the method includes providing written instructions for instructing the instructee to move the indicia to the desired position.

Although the embodiments disclosed herein are described with respect to ballet and ballet apparel, aspects of the disclosed garments and methods can be applied to other activities and apparel. Other activities can include, for example, yoga, physical therapy, and sports. As used herein, the term instructee is inclusive of anyone receiving instruction from a video, written instructions, an instructor, a teacher, a coach, or other person. Thus, an instructee can be a student, patient, player, or prisoner, for example. As used herein, the term garment is inclusive of wearable articles including clothing, shoes, gloves, tights, pants, shoes, slippers, hats, and the like. In at least one representative embodiment, tights can include spirals that lead from the back of the upper leg through the inner part of the thigh to the outside of the thigh to encourage proper turnout.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

What is claimed is:

1. A garment to facilitate communication between an instructor and an instructee, comprising:
a wearable article; and
indicia positioned on the wearable article to correspond to a feature of the human body when worn by an instructee;
wherein the instructor can refer to the indicia to communicate to the instructee how to move the indicia to a desired position by moving the trainee's anatomical features, thereby achieving a desired anatomical configuration.

2. The garment of claim 1, wherein the indicia comprises a first stripe positioned on the wearable article extending horizontally under the bust of the instructee.

3. The garment of claim 2, wherein the indicia comprises a second stripe positioned on the wearable article extending horizontally across the hips of the instructee.

4. The garment of claim 3, wherein the indicia comprises a first triangle positioned adjacent the first stripe.

5. The garment of claim 4, wherein the indicia comprises a second triangle positioned adjacent the second stripe.

6. The garment of claim 1, wherein the wearable article is a leotard.

7. The garment of claim 1, wherein the wearable article is a ballet slipper.

8. A garment, comprising:
an article wearable by a user; and
indicia positioned on the article to communicate to the user a desired anatomical configuration;
wherein the indicia is positioned to correspond to one or more of the user's anatomical features when worn by the user.

9. The garment of claim 8, wherein the indicia comprises a first stripe positioned on the article extending horizontally under the bust of the user.

10. The garment of claim 9, wherein the indicia comprises a second stripe positioned on the article extending horizontally across the hips of the user.

11. The garment of claim 10, wherein the indicia comprises a first triangle positioned adjacent the first stripe.

12. The garment of claim 11, wherein the indicia comprises a second triangle positioned adjacent the second stripe.

13. The garment of claim 8, wherein the article is a leotard.

14. The garment of claim 8, wherein the article is a ballet slipper.

15. The garment of claim 8, further comprising printed instructions for communicating to a user how to position the indicia to achieve the desired anatomical configuration.

16. A method of instructing an instructee to achieve a desired anatomical configuration, the method comprising:
providing the instructee with a garment comprising:
an article wearable by the instructee; and
indicia positioned on the article adjacent one or more of the instructee's anatomical features when worn by the instructee; and
instructing the instructee to move the indicia to a desired position by moving the instructee's anatomical features, thereby achieving a desired anatomical configuration.

17. The method of claim 16, further comprising verbally instructing the instructee with reference to the indicia.

18. The method of claim 16, further comprising providing written instructions for instructing the instructee to move the indicia to the desired position.

19. The method of claim 16, wherein the article is a shoe.

20. The method of claim 16, wherein the article is a leotard.
